(19) United States
(12) Patent Application Publication
(10) Pub. No.: US 2024/0405580 A1
(43) Pub. Date: Dec. 5, 2024

(54) PROTECTIVE CHARGING CASE SYSTEM FOR ELECTRONIC DEVICES

(71) Applicant: Urban Armor Gear, LLC, Laguna Niguel, CA (US)

(72) Inventors: Carlos del Toro, Foothill Ranch, CA (US); Yu Ta Lin, Temple City, CA (US)

(21) Appl. No.: 18/735,015

(22) Filed: Jun. 5, 2024

Related U.S. Application Data
(60) Provisional application No. 63/471,192, filed on Jun. 5, 2023.

(51) Int. Cl. H02J 7/00; A45C 11/00; A45C 15/00; H02J 50/10

(52) U.S. Cl. CPC H02J 7/0045; A45C 11/00; A45C 15/00; H02J 7/0048; H02J 50/10; A45C 2011/002; A45C 2011/003

(57) ABSTRACT

Protective charging case systems usable with electronic devices are provided. The systems may include cases with removable batteries, where the electronic devices can be attached to the cases and be wirelessly charged by the batteries. The batteries can be charged in multiple ways, whether or not they are installed in the cases. The protective charging case system and its components can result in increased user satisfaction and improved working conditions, due to the maximized operation time of the electronic devices.

### CROSS-REFERENCE

This application claims priority to U.S. Provisional Patent Application No. 63/471,192, filed on Jun. 5, 2023, which is incorporated by reference in its entirety herein.

### TECHNICAL FIELD

This application generally relates to protective charging case systems usable with electronic devices. In particular, this application relates to protective charging case systems including cases with removable batteries, where the electronic devices can be attached to the cases and be wirelessly charged by the batteries, and where the batteries can be charged in multiple ways.

### BACKGROUND

Electronic devices, such as smartphones, tablet computers, and the like, are widely used by workers and other users in retail, restaurant, industrial, and/or other enterprise scenarios for various functions, such as for point of sale, ordering, inventory management, and numerous other uses. When used in these types of enterprise scenarios, the electronic devices may often be subject to harsh conditions and rough handling. It may therefore be prudent to protect the electronic devices from damage due to impacts that can occur from drops, falls, etc. Cases for electronic devices are typically used for such impact protection in order to reduce the potential for damage, such as cracked screens, broken ports, scratches, etc.

Furthermore, electronic devices are often used for long durations in enterprise scenarios, e.g., for the length of a worker's shift, which can be demanding on the batteries of the electronic devices. Since workers in enterprise scenarios typically rely on the electronic devices to perform tasks related to their jobs, it can be inconvenient and frustrating when the electronic devices run out of power. While the electronic devices could be plugged in (e.g., to a wall outlet) for recharging, this can be limiting since the users would not be able to move about.

Accordingly, there is an opportunity for protective case systems for electronic devices that address these concerns. More particularly, there is an opportunity for protective cases with batteries that can be charged in multiple ways and that can be used to wirelessly charge electronic devices.

### SUMMARY

The invention is intended to solve the above-noted problems by providing systems, cases, and batteries that are designed to, among other things: (1) enable a rechargeable battery that is attachable to a protective case to be charged through a charging port or through conductive terminals that are in electrical contact with corresponding conductive terminals on the protective case or on a docking station; (2) provide current for charging the battery through the protective case via an electrical connection between external conductive terminals on the protective case to internal conductive terminals that can electrically contact the battery's conductive terminals; (3) permit wireless charging of the electronic device by the battery when the battery is installed in the case; and (4) enable quick and easy swapping out of the battery with a different battery without affecting operation of the electronic device.

In an embodiment, a protective case system for an electronic device may include (A) a case adapted to removably engage with the electronic device, and (B) a rechargeable battery removably engaged with a receiving portion of the case. The case may include one or more external conductive terminals disposed on an external surface of the case, a receiving portion adapted to releasably hold the rechargeable battery, and one or more internal conductive terminals disposed within the receiving portion and electrically connected to the one or more external conductive terminals. The battery may be configured to wirelessly charge the electronic device, and include a charging port configured to receive current to charge the rechargeable battery, and one or more battery conductive terminals adapted to electrically contact the one or more internal conductive terminals. The battery conductive terminals may be configured to receive current to charge the rechargeable battery from the one or more internal conductive terminals.

In another embodiment, a rechargeable battery may include a charging port configured to receive current to charge the rechargeable battery, and one or more battery conductive terminals adapted to electrically contact one or more corresponding conductive terminals. The battery conductive terminals may be configured to receive current to charge the rechargeable battery from the one or more corresponding conductive terminals. The rechargeable battery may be configured to be removably engaged with a protective case, and to wirelessly charge an electronic device engaged to the protective case.

In a further embodiment, a protective case may include one or more external conductive terminals disposed on an external surface of the case, a receiving portion adapted to releasably hold a rechargeable battery, and one or more internal conductive terminals disposed within the receiving portion and electrically connected to the one or more external conductive terminals. The protective case may be adapted to be removably engaged with an electronic device. The rechargeable battery may be configured to wirelessly charge the electronic device and further configured to receive current to charge the rechargeable battery through one or more of a charging port or a battery conductive terminal adapted to be in electrical contact with the one or more internal conductive terminals.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a front view of an embodiment of a protective case that is removably engaged with a representative electronic device.

FIG. 2 is a front view of the protective case of FIG. 1 without the electronic device.

FIG. 3 is a rear view of the protective case of FIG. 1 that is removably engaged with the electronic device and with a rechargeable battery.

FIG. 4 is a rear view of the protective case of FIG. 1 without the electronic device and without the rechargeable battery.

FIG. 5 is a top view of the protective case of FIG. 1.

FIG. 6 is a bottom view of the protective case of FIG. 1.

FIG. 7 is a right side view of the protective case of FIG. 1.

FIG. 8 is a left side view of the protective case of FIG. 1.

FIG. 9 is a perspective view of an embodiment of a rechargeable battery that can be attached to the protective case of FIG. 1.

FIG. 10 is a bottom view of the rechargeable battery of FIG. 9.

FIG. 11 is a perspective view of an embodiment of a docking station for a protective case and a rechargeable battery.

FIG. 12 is a perspective view of an embodiment of a docking station for multiple protective cases.

FIGS. 13-14 are perspective views of an embodiment of a docking station for multiple rechargeable batteries.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

The protective case system and its components described herein can enable users to protect electronic devices from impact damage while being able to wirelessly charge the electronic devices using a rechargeable battery. The rechargeable battery may be removably attached to a protective case, and the case may be configured to attach to and protect an electronic device, such as a smartphone, tablet computer, etc. The battery may be charged by a power source through a charging port, or when the battery is attached to the case, the battery may be charged through conductive terminals that are in electrical contact with corresponding conductive terminals in the case or on a docking station.

When the battery is attached to the case, the current for charging the battery may be provided via internal wiring in the case that enables an electrical connection between the conductive terminals in the case and conductive terminals on an exterior of the case. The conductive terminals on the exterior of the case may be connected to a power source, such as through contacting corresponding conductive terminals on the docking station. As such, the protective case system and its components described herein can enable electronic devices to be suitably protected while maximizing the operation time of the electronic devices. The battery can also be charged using a docking station, either by itself or when the battery is attached to the case. Use of the protective charging case system and its components can therefore result in increased user satisfaction and improved working conditions.

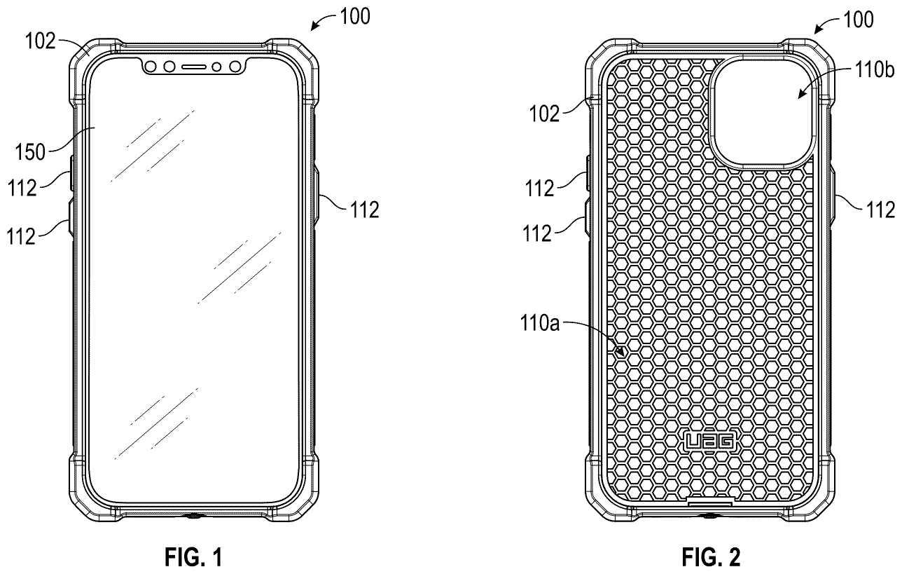

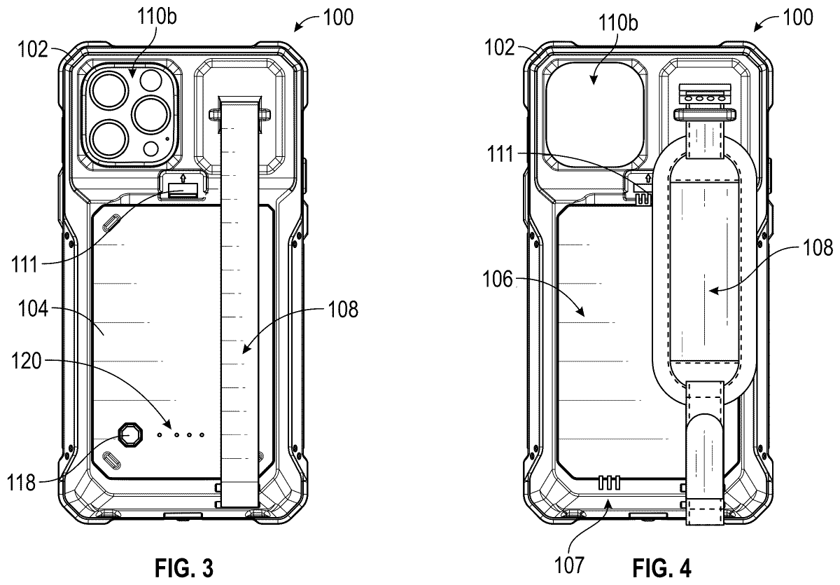

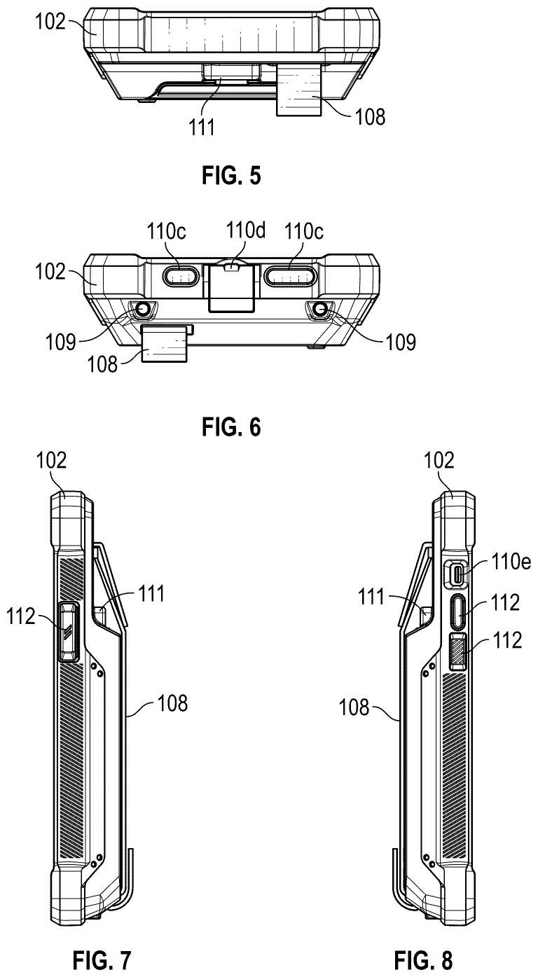

FIGS. 1 and 2 show front views of an exemplary protective case system 100, FIGS. 3 and 4 show rear views of the protective case system 100, and FIGS. 5-8 respectively show top, bottom, right side, and left side views of the protective case system 100. In particular, FIGS. 1 and 3 show the protective case system 100 with a case 102 attached to a representative electronic device 150, while FIGS. 2, 4, and 5-8 show the protective case system 100 that is not attached to an electronic device. It should be understood that the electronic device 150 shown in FIGS. 1 and 3 is merely exemplary, and that any suitable electronic device may be used with the protective case system 100. It should also be understood that the protective case system 100 may have any suitable shape and/or dimensions to be securely attached to a particular electronic device.

The protective case system 100 may include a case 102, a rechargeable battery 104 that is installable into a receiving portion 106 of the case 102, and a hand strap 108. The case 102 may be formed of one or more components made from suitable materials, such as polycarbonate, thermoplastic polyurethane, etc. that can be connected, molded, or otherwise attached to one another to form an integral unit. In embodiments, the case 102 and/or the battery 104 may be protected against contaminants by, for example, having an anti-microbial finish and properties, and/or may be certified to be cleaned with medical grade wipes. The electronic device 150 may be protected by the case 102 to reduce shock due to impact and other forces. The case 102 may enable this protection of the electronic device 150 by having certain properties (e.g., rigidity, elasticity, etc.) and by including any number of suitable features (e.g., bumpers, edges, etc.). The protection afforded by the case 102 may conform to a drop test standard, such as the MIL-STD 810G military standard and/or other standards.

The case 102 may include any number of openings 110 that are shaped and dimensioned to allow parts of the electronic device 150 to be uncovered and/or to be accessible to a user. For example, the screen of the electronic device 150 may be accessible through opening 110a, the camera of the electronic device 150 may be exposed through opening 110b, and speakers, sensors, and/or other components of the electronic device 150 may be exposed through openings 110c on the bottom of the case 102. In addition, a port of the electronic device 150 may be accessible through an opening 110d on the bottom of the case 102, and a switch or other user interface mechanism may be accessible through an opening 110e on a left side of the case 102. In embodiments, the openings 110 may be covered and/or protected to protect the electronic device 150 from dust, water, and other contaminants. For example, the opening 110d for the port of the electronic device 150 may have a removable cover (as shown in FIG. 6), and the openings 110c for the speakers of the electronic device 150 may be protected by non-woven mesh acoustic vents. It should be understood that the openings 110 shown in the figures for the electronic device 150 are merely exemplary, and that the case 102 may include any number and/or sizes of suitable openings 110 for a particular electronic device.

The case 102 may further include any number of flexible protrusions 112 that can cover and protect buttons (or other user interface mechanisms) on the electronic device 150 while still allowing a user to interact with the buttons. For example, the flexible protrusions 112 can be pressed by a user to activate the underlying buttons of the electronic device 150. The strap 108 may be removably attached to the rear of the case 102 to enable a user to more securely hold the case 102. The strap 108 may be adjustable using a suitable fastener, such as a hook and loop fastener, snaps, buckles, etc. The strap 108 may be made of any suitable material, such as fabric or silicone. In embodiments, the strap 108 may be elastic and/include a padded portion (e.g., as shown in FIG. 4).

A screen protector may be installed on the screen of the electronic device 150. The screen protector may be infused with non-Newtonian fluids to provide a high shock resistance. An outer surface of the screen protector may be plated with oleophobic materials to resist liquids, oils, fingerprints, etc., while still providing suitable clarity. The screen protector may be shatterproof such that it can act as a laminate in case the screen of the electronic device 150 cracks. The screen protector may have a 9H hardness, be certified to be cleaned by medical grade wipes, and may be easily installed with a suitable tool.

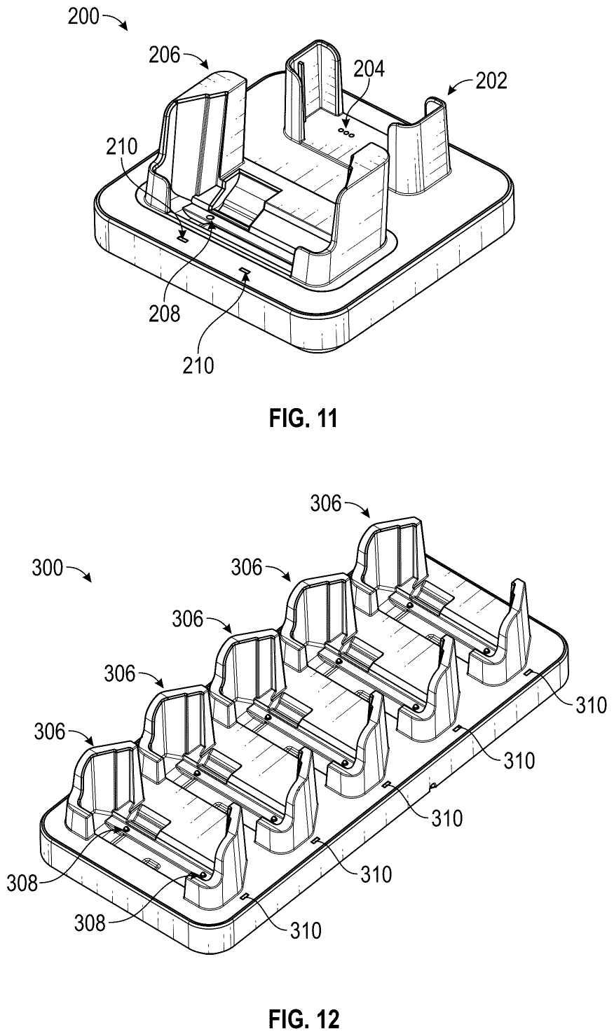

As best seen in FIGS. 3 and 4, the battery 104 may be removably installed into a receiving portion 106 of the case 102. The receiving portion 106 may be shaped and dimensioned to hold the battery 104. The case 102 may include a locking mechanism, such as a latch 111, to retain the battery 104 within the receiving portion 106. In some embodiments, the battery 104 may be secured to the receiving portion 106 and/or the case 102 using a screw or other suitable fastener. In embodiments, the battery 104 may also be removably placed into a battery dock 202 of a docking station 200, as shown in FIG. 11, and/or into a battery dock 402 of a battery docking station 400, as shown in FIGS. 13-14. The battery 104, the receiving portion 106, the battery dock 202, and/or the battery docking station 400 may include one or more orientation and/or alignment features to assist in placing the battery 104 in the receiving portion 106, the battery dock 202, and the battery dock 402, e.g., to ensure that conductive terminals 114 of the battery 104 correctly make contact with corresponding conductive terminals of the receiving portion 106, the battery dock 202, and the battery dock 402. As described in more detail below, the battery 104 may be charged both when the battery 104 is installed in the case 102 and when the battery 104 is not installed in the case 102 (e.g., in the battery dock 202 of the docking station 200, in the battery dock 402 of the battery docking station 400, or through a charging port 116). While the battery docking station 400 is shown as having five separate battery docks 402, any number of battery docks 402 on the battery docking station 400 are contemplated and possible.

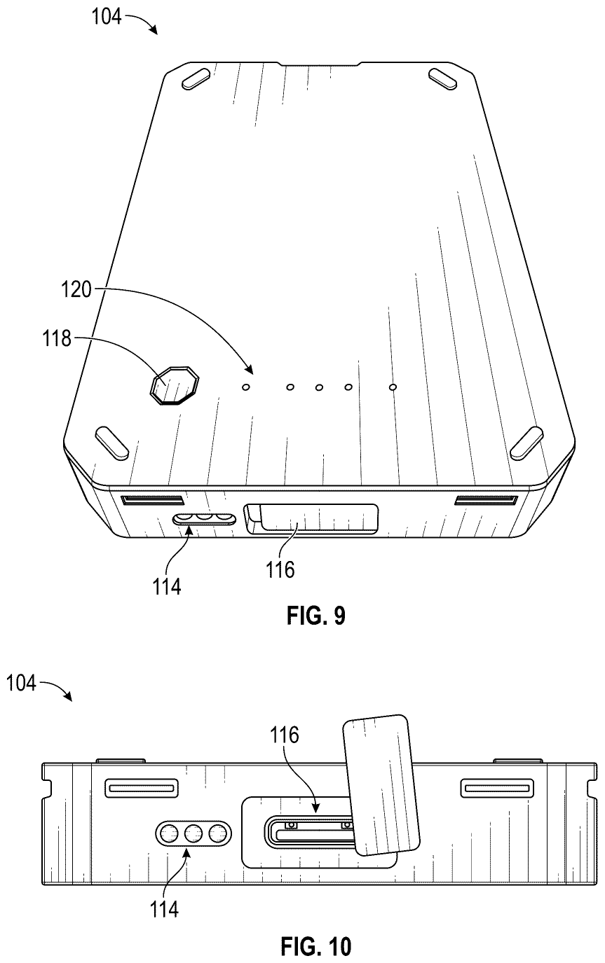

The battery 104 may be any suitable voltage (e.g., 3.7 V, 5 V, etc.), have any suitable capacity (e.g., 3000 mAh, 5000 mAh, etc.), and may be include a lithium polymer, lithium ion, nickel cadmium, or another type of rechargeable battery. As best seen in FIGS. 9 and 10, the battery 104 may be charged through one or more conductive terminals 114. The conductive terminals 114 may contact with corresponding conductive terminals to create an electrical connection such that current is received by the battery 104. In some embodiments, the conductive terminals 114 of the battery 104 may be configured to contact conductive terminals 107 in the receiving portion 106 of the case 102, i.e., when the battery 104 is installed in the receiving portion 106. In other embodiments, the conductive terminals 114 of the battery 104 may be configured to contact conductive terminals 204 of the battery dock 202 of the docking station 200, as shown in FIG. 11, e.g., when the battery 104 is inserted into the battery dock 202. Similar conductive terminals (not shown) of the battery dock 402 of the battery docking station 400 may also be configured to contact the conductive terminals 114 of the battery 104. Indicators 210 on the docking station 200 and indicators 410 on the battery docking station 400 may denote the charging state of the battery 104 by showing different colors, flashing, etc. In an embodiment, the indicators 210, 410 may be a flashing orange color when charging a battery 104 and a constant green color when the battery 104 is fully charged. The indicators 210, 410 may be light emitting diodes or any other suitable lighting device.

The conductive terminals 114 of the battery 104 may be of the same number (e.g., three) as the conductive terminals 107 of the case 102, the conductive terminals 204 of the battery dock 202, and the conductive terminals on the battery dock 402. The various conductive terminals may be able to conduct electricity and/or signals (e.g., temperature information, voltage information, etc.). The conductive terminals 114 of the battery 104, the conductive terminals 107 of the case 102, the conductive terminals 204 of the battery dock 202, and the conductive terminals of the battery dock 402 may be made of any suitable material (e.g., copper, gold, etc.), and be any suitable configuration (e.g., pogo pins, contacts, etc.) such that an electrical connection can be made between corresponding terminals when they contact one another.

Current for charging the battery 104 may be received at the conductive terminals 114 when a suitable power source is connected to the conductive terminals 107 of the case 102, to the conductive terminals 204 of the battery dock 202, or to the conductive terminals of the battery dock 402. The conductive terminals 107 of the case 102 may be electrically connected to conductive terminals 109 on an exterior surface of the case 102, such as on the bottom of the case 102 as seen in FIG. 6. The conductive terminals 107 and the conductive terminals 109 may be electrically connected to one another via wiring (not shown) that is internal to the case 102.

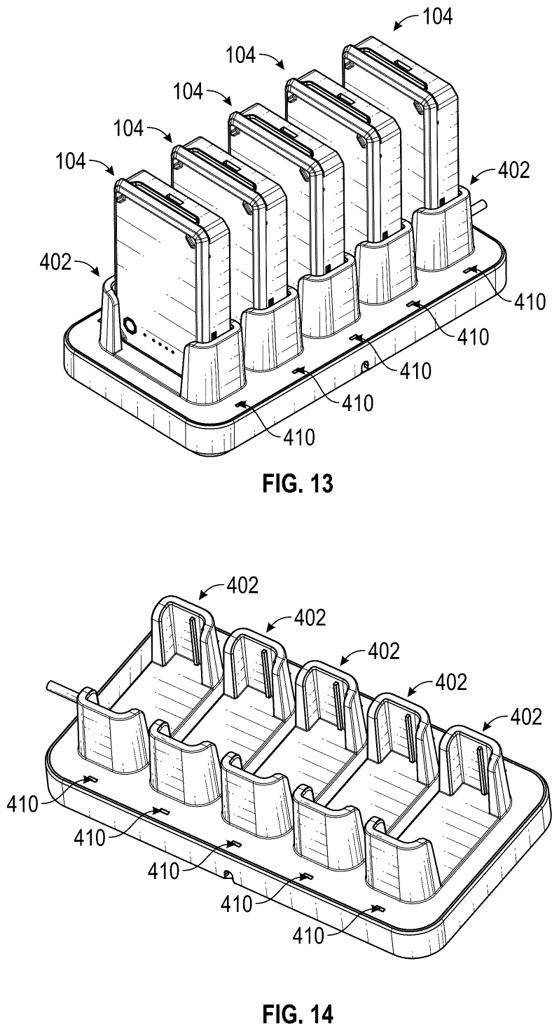

The case 102 may be removably placed into a case dock 206 of a docking station 200 (shown in FIG. 11) or a case dock 306 of a docking station 300 (shown in FIG. 12). The conductive terminals 109 on the exterior of the case 102 may be configured to contact conductive terminals 208 of the case dock 206 and conductive terminals 308 of the case dock 306, e.g., when the case 102 is inserted into the case dock 206 or the case dock 306. Indicators 210, 310 on the docking station 200, 300 may denote the charging state of the battery 104 by showing different colors, flashing, etc. The indicators 210, 310 may be light emitting diodes or any other suitable lighting device. In this way, when the case dock 206 or 306 is connected to a suitable power source, current may be received at the conductive terminals 114 of the battery 104 to charge the battery 104 by: (1) the conductive terminals 114 being in electrical contact with the conductive terminals 107 in the receiving portion 106 of the case 102, (2) the conductive terminals 107 being electrically wired with the conductive terminals 109 on the exterior of the case 102, and (3) the conductive terminals 109 being in electrical contact with the conductive terminals 208 or 308 of the case dock 206 or 306, respectively.

While the docking station 200 is shown with a single battery dock 202 and a single case dock 206, any number of battery docks 202 and case docks 206 on the docking station 200 are contemplated and possible. Similarly, while the docking station 300 is shown as having five separate case docks 306, any number of case docks 306 on the docking station 300 are contemplated and possible. In embodiments, the docking station 200, docking station 300, and battery docking station 400 may be protected against contaminants by, for example, having an anti-microbial finish and properties, and/or may be certified to be cleaned with medical grade wipes. In some embodiments, the docking station 200, docking station 300, and battery docking station 400 may include an integrated slot, e.g., T-Lock slot, to which a security cable or other security device can be attached.

In embodiments, the battery 104 may also be charged through a charging port 116. The charging port 116 may be conform to the Universal Serial Bus (USB) standard, e.g., Type A, Type B, Mini-USB, Micro-USB, USB-C, etc., or may conform to another appropriate standard. The charging port 116 may be protected by a removable cover, as shown in FIG. 10, to prevent contamination or inadvertent connections. The charging port 116 may be connected to a suitable connector and cable so that a power source (e.g., a charger plugged into a power outlet) can deliver current to the battery 104 for charging.

The battery 104 may receive a suitable amount of power when being charged, such as 10 W (i.e., 5 V at 2 A), whether current is being received at the charging port 116, at the conductive terminals 114 via the conductive terminals 107 of the case 102, at the conductive terminals 114 via the conductive terminals 204 of the battery dock 202, or at the conductive terminals 114 via the conductive terminals of the battery dock 402. Accordingly, as detailed above, users have a variety of flexible options for charging the battery 104 whether or not the battery 104 is installed in the case 102.

The battery 104 may be capable of transferring power to the electronic device 150 by supplying current through wireless inductive charging, e.g., such as using the Qi standard or other appropriate standard. For example, when (1) the case 102 is attached to an electronic device 150 and (2) the battery 104 is installed in the receiving portion 106 of the case 102, the battery 104 may wirelessly charge the electronic device 150, such as to wirelessly charge the internal battery of the electronic device 150. In embodiments, the battery 104 may detect the presence of the electronic device 150 and begin wirelessly charging. In other embodiments, a button 118 on the battery 104 may be depressed by a user, e.g., once, to power the battery 104 on and to begin wireless charging of the electronic device 150 by the battery 104. The button 118 on the battery 104 may be depressed by a user, e.g., twice, to power down the battery 104. The battery 104 may wirelessly supply a suitable amount of power (e.g., 5 W) to the electronic device 150.

Accordingly, the electronic device 150 may be wirelessly charged on a continuous basis by the battery 104 to extend the operation time of the electronic device 150. Moreover, when the battery 104 has low or no charge, the battery 104 can be quickly and easily swapped out with a different charged battery 104 without affecting the operation of the electronic device 150. This “hot swapping” feature is enabled by the fact that the electronic device 150 can operate off of its own internal battery regardless of the presence and/or state of the battery 104. Regardless, the battery 104 may itself be charged, as described previously, while the battery 104 wirelessly charges the electronic device 150.

The battery 104 may include a button 118 and one or more indicators 120, as shown in FIG. 9. The button 118 may be depressed to show a status of the battery 104 on the indicators 120, such as the amount of charge as denoted by lighting a particular number of indicators 120. The indicators 120 on the battery 104 may also denote whether the battery 104 is being charged, e.g., by flashing. Whether the battery 104 is wirelessly charging an electronic device 150 may also be indicated by one or more of the indicators 120, such as by changing to different colors and/or flashing. The indicators 120 may be light emitting diodes or any other suitable lighting device.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A protective case system for an electronic device, comprising:
(A) a case adapted to removably engage with the electronic device, comprising:
one or more external conductive terminals disposed on an external surface of the case;
a receiving portion adapted to releasably hold a rechargeable battery; and
one or more internal conductive terminals disposed within the receiving portion and electrically connected to the one or more external conductive terminals; and
(B) the rechargeable battery removably engaged with the receiving portion of the case, and configured to wirelessly charge the electronic device, the rechargeable battery comprising:
a charging port configured to receive a first current to charge the rechargeable battery; and
one or more battery conductive terminals adapted to electrically contact the one or more internal conductive terminals, and configured to receive a second current to charge the rechargeable battery from the one or more internal conductive terminals.

2. The protective case system of claim 1, wherein the receiving portion of the case comprises a locking mechanism adapted to removably secure the rechargeable battery to the receiving portion.

3. The protective case system of claim 1, wherein the rechargeable battery further comprises one or more wireless charging indicators configured to denote a status of the wireless charging of the electronic device by the rechargeable battery.

4. The protective case system of claim 3, wherein the rechargeable battery further comprises one or more battery charging indicators configured to denote a status of a state of the rechargeable battery.

5. The protective case system of claim 3, wherein the rechargeable battery further comprises one or more buttons configured to control the wireless charging of the electronic device by the rechargeable battery.

6. The protective case system of claim 1, wherein the charging port of the rechargeable battery comprises a USB-C port.

7. The protective case system of claim 1, wherein the one or more battery conductive terminals of the rechargeable battery are further adapted to electrically contact one or more charging terminals of a docking station.

8. The protective case system of claim 1, wherein the one or more external conductive terminals of the case are adapted to electrically contact one or more charging terminals of a docking station.

9. The protective case system of claim 1, wherein the case further comprises a strap removably attached to the case, the strap configured to enable the case to be securely grasped by a user.

10. A rechargeable battery, comprising:
a charging port configured to receive a first current to charge the rechargeable battery; and
one or more battery conductive terminals adapted to electrically contact one or more corresponding conductive terminals, and configured to receive a second current to charge the rechargeable battery from the one or more corresponding conductive terminals;
wherein the rechargeable battery is configured to be removably engaged with a protective case, and to wirelessly charge an electronic device engaged to the protective case.

11. The rechargeable battery of claim 10, further comprising one or more wireless charging indicators configured to denote a status of the wireless charging of the electronic device by the rechargeable battery.

12. The rechargeable battery of claim 11, further comprising one or more battery charging indicators configured to denote a status of a state of the rechargeable battery.

13. The rechargeable battery of claim 11, further comprising one or more buttons configured to control the wireless charging of the electronic device by the rechargeable battery.

14. The rechargeable battery of claim 10, wherein the charging port of the rechargeable battery comprises a USB-C port.

15. The rechargeable battery of claim 10, wherein the one or more corresponding conductive terminals comprise one or more conductive terminals of the protective case, or one or more battery charging terminals of a docking station.

16. The rechargeable battery of claim 10, further comprising one or more locating mechanisms adapted to engage with one or more corresponding receiving mechanisms of a docking station.

17. A protective case, comprising:
one or more external conductive terminals disposed on an external surface of the case;
a receiving portion adapted to releasably hold a rechargeable battery; and
one or more internal conductive terminals disposed within the receiving portion and electrically connected to the one or more external conductive terminals;
wherein the protective case is adapted to be removably engaged with an electronic device; and
wherein the rechargeable battery is configured to wirelessly charge the electronic device and further configured to receive current to charge the rechargeable battery through one or more of a charging port or a battery conductive terminal adapted to be in electrical contact with the one or more internal conductive terminals.

18. The protective case of claim 17, wherein the receiving portion comprises a locking mechanism adapted to removably secure the rechargeable battery to the receiving portion.

19. The protective case of claim 17, wherein the one or more external conductive terminals are adapted to electrically contact one or more charging terminals of a docking station.

20. The protective case of claim 17, further comprising a strap removably attached to the protective case, the strap configured to enable the protective case to be securely grasped by a user.
